(19) United States
(12) Patent Application Publication
(10) Pub. No.: US 2026/0178983 A1
(43) Pub. Date: Jun. 25, 2026

(54) NON-TRANSITORY COMPUTER-READABLE MEDIUM, MACHINE LEARNING METHOD AND MACHINE LEARNING DEVICE

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/539,487

(22) Filed: Feb. 13, 2026

Related U.S. Application Data
(63) Continuation of application No. PCT/JP2023/033767, filed on Sep. 15, 2023.

(51) Int. Cl. G06N 20/00; G06F 17/11; G06N 3/084

(52) U.S. Cl. CPC G06N 20/00; G06F 17/11; G06N 3/084

(57) ABSTRACT

There is provided a non-transitory computer-readable medium storing a calculation program for causing a computer to execute a process. The process includes, training a model by using a loss term corresponding to a degree of continuity or discreteness of a variable to be optimized as a cost function in a search process that incorporates continuous relaxation into a discrete optimization problem, and changing the loss term as the search process progresses.

### CROSS-REFERENCE TO RELATED APPLICATION

This application is a continuation application of PCT/JP2023/033767, filed on Sep. 15, 2023, the entire contents of which are incorporated herein by reference.

### FIELD

A certain aspect of the present embodiments relates to a non-transitory computer-readable medium, a machine learning method, and a machine learning device.

### BACKGROUND

Technologies for optimizing complex combinations have been disclosed (see, for example, Schuetz, M. J., Brubaker, J. K., and Katzgraber, H. G. (2022a). Combinatorial optimization with physics-inspired graph neural networks. Nature Machine Intelligence, 4 (4): 367-377, and Schuetz, M. J., Brubaker, J. K., Zhu, Z., and Katzgraber, H. G. (2022b). Graph coloring with physics-inspired graph neural networks. Physical Review Research, 4(4):043131.)

### SUMMARY

According to an aspect of the present disclosure, there is provided a non-transitory computer-readable medium storing a calculation program for causing a computer to execute a process, the process including: training a model by using a loss term corresponding to a degree of continuity or discreteness of a variable to be optimized as a cost function in a search process that incorporates continuous relaxation into a discrete optimization problem, and changing the loss term as the search process progresses.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates conversion to a graph embedding vector;

FIG. 2 illustrates results of a maximum independent set on a 50-regular random graph;

FIG. 3 illustrates results applied to MIS;

FIG. 4A illustrates results applied to MIS;

FIG. 4B illustrates results applied to MIS;

FIG. 5A is a functional block diagram of an overall configuration of an information processing device according to an embodiment;

FIG. 5B is a hardware configuration diagram of an information processing device;

FIG. 6 is a flowchart illustrating an example of an operation of an information processing device during machine learning; and

FIG. 7 is a flowchart of an example of an operation of an information processing device using results of machine learning.

### DESCRIPTION OF EMBODIMENTS

In combinatorial optimization, a continuous relaxation solution method using a machine learning (training) model is considered for searching for an optimal solution. However, with the continuous relaxation method solution, the solution found may differ from the exact solution. This can result in a decrease in the accuracy of solving combinatorial optimization problems.

Optimization problems exist in a variety of industries, including manufacturing and distribution. Combinatorial optimization problems, which optimize combinations, are particularly important in the field of optimization. Combinatorial optimization problems are applied in a variety of fields, including transportation, logistics, communications, and finance.

First, the continuous relaxation solution method using a machine learning model will be described. The continuous relaxation solution method is a technique that, instead of solving a discrete optimization problem, relaxes the discrete optimization problem and solves the corresponding continuous optimization problem.

As an example, the continuous relaxation solution method in the QUBO format will be described. QUBO stands for Quadratic Unconstrained Binary Optimization, a format that allows binary optimization without quadratic constraints.

First, the QUBO format optimization problem can be expressed as a loss function, as expressed by the following formula (1). Problems such as the Traveling Salesman Problem, the Knapsack Problem, and the Graph Coloring Problem can be mapped using the QUBO format. x is a vector containing N elements, expressed as 0 and 1. x^{T} is the transpose matrix of x.

$$\begin{matrix}[ Formula 1 ] & \\ {H}_{QUBO} ( x ) = {x}^{T} Qx , x ∈ {\{ 0 , 1 \}}^{N} & ( 1 )\end{matrix}$$

In the continuous relaxation solution method, the QUBO in the formula (1) above is relaxed to a simpler form. As an example, the formula (1) above is relaxed to a hypercubic lattice. For example, the formula (1) above can be expressed as the following formula (2). In the formula below, [0,1]^{N} represents an N-dimensional hypercubic lattice with values of 0 or 1.

$$\begin{matrix}[ Formula 2 ] & \\ {\hat{H}}_{QUBO} ( p ) = {p}^{T} Qp , p ∈ {[ 0 , 1 ]}^{N} & ( 2 )\end{matrix}$$

However, even with continuous relaxation of the QUBO, the loss landscape may still be complex. Furthermore, the optimal solution after relaxation can differ significantly from the exact optimal solution.

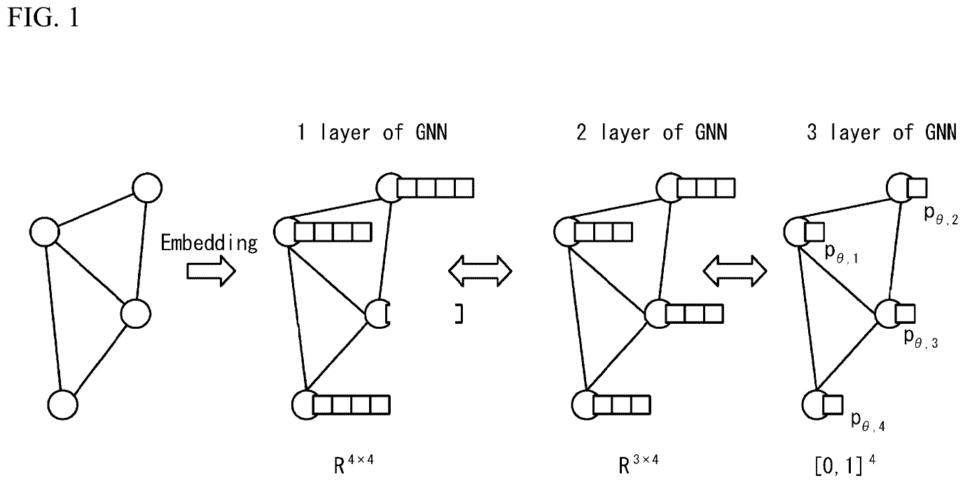

Next, p in the above formula (2) may be parameterized using a GNN (Graph Neural Network) and optimized using the loss function in the following formula (3). In the following formula (3), G in the optimization problem is converted into an embedding vector h_{G,φ}. G is the feature vector of the graph in the GNN. For example, in FIG. 1, the graph feature vector G is converted into a graph embedding vector with the number of nodes N=4 and the number of edges E=4. For example, the optimization problem for p is reduced to optimizing (θ, φ) in the above formula (3), which is characterized by the parameters of the GNN. Note that in the following formula (3), R^{E×N} is an E×N-dimensional Euclidean space.

$$\begin{matrix}[ Equation 3 ] & \\ {\hat{H}}_{QUBO} ( θ , ϕ ) = {p}_{θ , G}^{T} ( {h}_{G , ϕ} ) {Qp}_{θ , G} ( {h}_{G , ϕ} ) , {p}_{θ , G} : {ℝ}^{E \times N} \to {[ 0 , 1 ]}^{N} & ( 3 )\end{matrix}$$

$$\begin{matrix}[ Equation 4 ] & \\ {θ}^{*} = arg {max}_{θ} {p}_{θ}^{T} {Qp}_{θ} & ( 4 )\end{matrix}$$

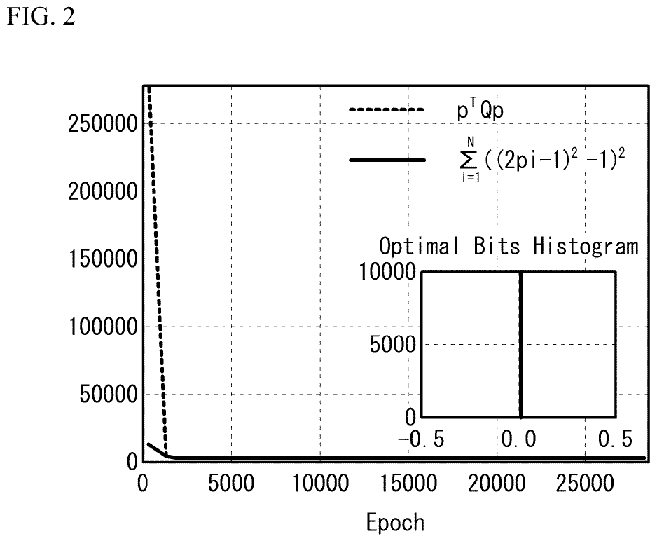

However, the continuous relaxation solution method is not adept at solving combinatorial optimization problems on graphs with high degrees (the number of edges connected to each node). For example, depending on the nature of the optimization problem, there is a risk that the search for an optimal solution does not progress and converges to a trivial discrete local solution p=(0, . . . , 0) at an early stage. FIG. 2 illustrates an example of a failure. FIG. 2 illustrates the results of a maximum independent set on a 50-regular random graph. The dotted line represents the cost function. The solid line represents the observable that measures the discrete-continuous difference. In the example of FIG. 2, a trivial discrete local solution is reached at an early stage of machine learning, and the search no longer progresses.

Therefore, the following embodiment describes an example in which the accuracy of the model can be improved, thereby improving the accuracy of solving combinatorial optimization problems.

### EMBODIMENT

First, the principle of the embodiment will be given.

For the discrete optimization minₚH(p) on a discrete vector p∈{0, . . . , p} N with q values, a penalty term R(p) is applied as a cost function, as expressed by the following formula (5). The penalty term R(p) is a loss term for controlling the degree of continuity and discreteness. I is assumed to be a parameter that characterizes the nature of the problem. The method of this embodiment is applicable not only to the QUBO format, but also to other formats. As an example, in the QUBO format, the QUBO matrix Q is the parameter that characterizes the problem.

$$\begin{matrix}[ Formula 5 ] & \\ {min}_{p} ( H ( p ; I ) + λ R ( p ) ) & ( 5 )\end{matrix}$$

A is a parameter for controlling the penalty term, and is a hyperparameter for controlling the degree of continuity and discreteness. For example, if 2<0, continuous solutions are preferred, and if 2>0, discrete solutions are preferred.

In this embodiment, as an example, as machine learning progresses, the hyperparameter λ is gradually changed from a negative value λ⁽⁰⁾<0 to a positive value λ(T)>0. As a result, the penalty term changes as machine learning progresses, from one in which the loss decreases the more continuous the discrete vector p is to one in which the loss increases the more continuous the discrete vector p is. λ's (0) to (T) represent, for example, the unit time for one step of learning θ and φ. In this embodiment, this method of gradually changing the penalty term as machine learning progresses is referred to as continuous relaxation annealing.

Continuous spaces are relatively easier to optimize, enabling a variety of searches. Therefore, it is preferable to perform diverse searches in a continuous space in the early stages of machine learning by adjusting the penalty term, and then naturally map continuous solutions to discrete solutions in the later stages of machine learning.

For example, when the continuous relaxation annealing of this embodiment is applied to a solution-finding method using a GNN, it can be considered as optimization with respect to θ and φ, as expressed in the following formula (6).

$$\begin{matrix}[ Formula 6 ] & \\ {\hat{H}}_{QUBO} ( θ , ϕ ) = {p}_{θ , G}^{T} ( {h}_{G , ϕ} ) {Qp}_{θ , G} ( {h}_{G , ϕ} ) + λ {\sum }_{i = 1}^{N} {( {( 2 {p}_{θ , G}^{T} ( {h}_{G , ϕ} ) - 1 )}^{2} - 1 )}^{2} & ( 6 )\end{matrix}$$

The method of annealing the hyperparameter A is arbitrary. Therefore, annealing can be performed in any manner, such as exponentially or linearly. For example, the hyperparameter λ may be gradually annealed using linear scheduling, as expressed by the following formula (7). Note that t represents the time in which one step of machine learning for θ and φ is taken as unit time. ε is a small positive constant.

$$\begin{matrix}[ Formula 7 ] & \\ {λ}^{t + 1} ← {λ}^{t} + ϵ , ϵ ∈ ℝ & ( 7 )\end{matrix}$$

The continuous relaxation annealing technique of this embodiment was applied to the Maximal Independent Set (MIS). MIS is a problem of finding the largest independent set on a graph. An independent set is a set of nodes such that adding any other vertex results in both edges of that set. A description will be given of the results of continuous relaxation annealing for an MIS problem with 10,000 nodes, applying λ=0.0 and λ=−3.0.

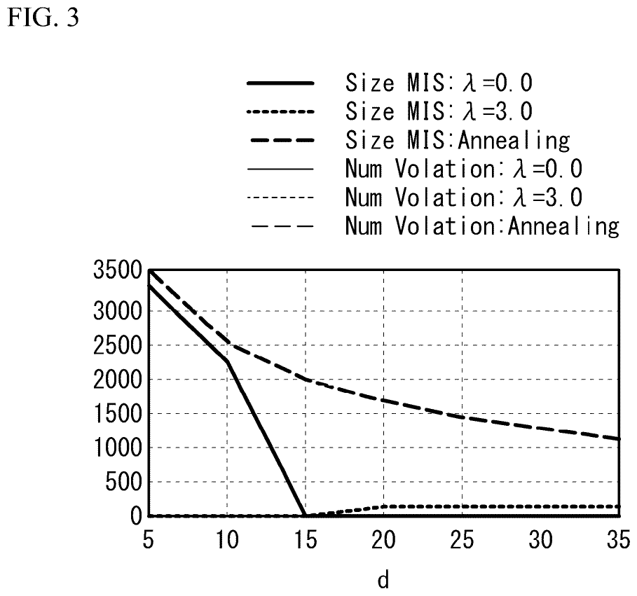

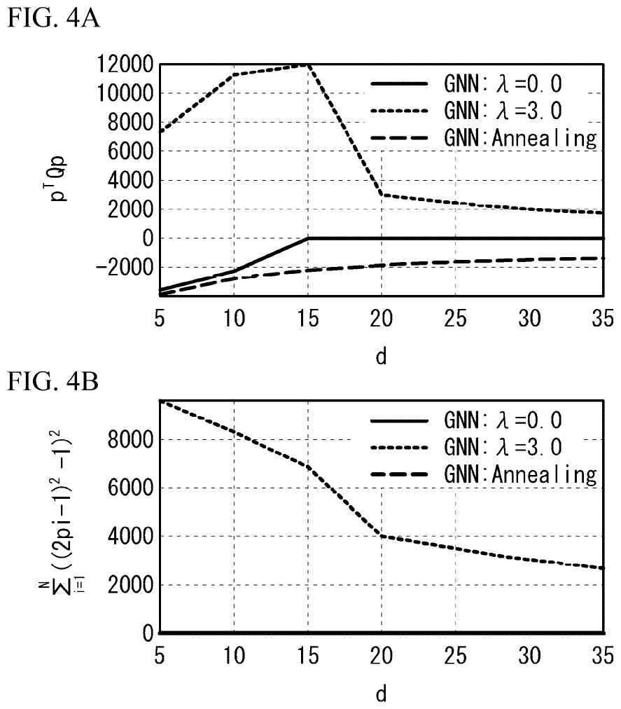

FIG. 3 illustrates the degree dependence (d dependence) of the size of the independent set. The vertical axis represents the size of the independent set. The larger the value on the vertical axis, the better the approximate solution obtained. When λ=0.0, as the degree of the graph increases, a trivial 0-bit solution is reached, and the independent set could not be found. In contrast, in this embodiment, a good approximate solution was obtained even when d was large. In FIG. 3, “Annealing” indicates the results of this embodiment. FIG. 4A illustrates the d-dependence of the cost function. FIG. 4B illustrates the d-dependence of the penalty term.

This embodiment may also be applied to a discrete variable p∈{1, . . . , q} (Potts variable) with q values. For example, p=(3, 2, q, . . . , q−1) is converted to a one-hot matrix as expressed by the following formula (8).

$$\begin{matrix}[ Formula 8 ] & \\ p = ( 3 , 2 , … , q - 1 ) \to 𝒫 = ( \begin{matrix}0 & 0 & 1 & ⋯ & 0 & 0 \\ 0 & 1 & 0 & ⋯ & 0 & 0 \\ ⋮ & ⋮ & ⋮ & ⋱ & ⋮ & ⋮ \\ 0 & 0 & 0 & ⋯ & 1 & 0\end{matrix} ) & ( 8 )\end{matrix}$$

In this case, the degree of continuity and discreteness can be controlled by applying the penalty term R(p) expressed by the following formula (9) to the one-hot vector.

$$\begin{matrix}[ Equation 9 ] & \\ R ( p ) = {\sum }_{i = 1}^{N} {( {‖ {p}_{i :} ‖}^{2} - 1 )}^{2} + {\sum }_{ij} ( {( {( 2 {p}_{ij} - 1 )}^{2} - 1 )}^{2} ) & ( 9 )\end{matrix}$$

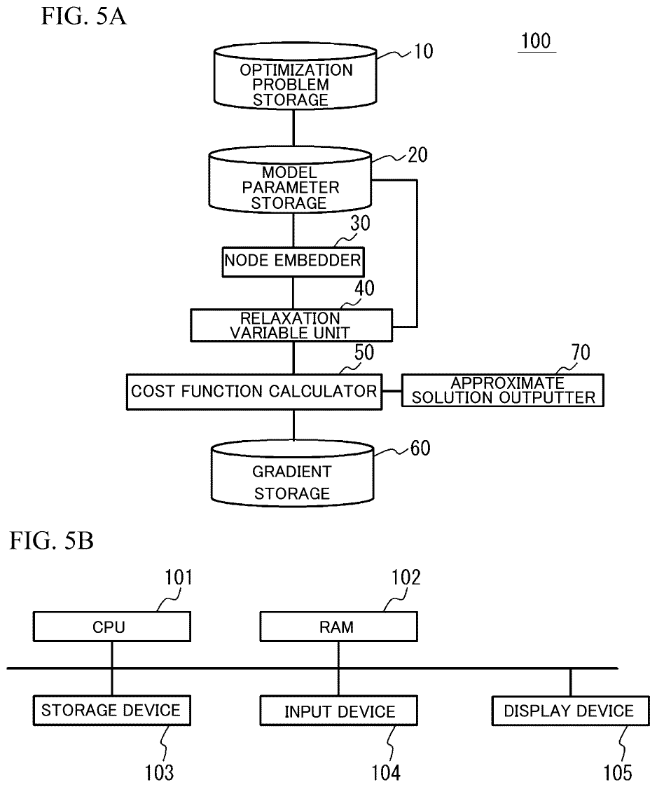

Next, the device configuration for implementing the above solution principle will be described. FIG. 5A is a functional block diagram of the overall configuration of an information processing device 100 according to the embodiment. The information processing device 100 is, for example, a server for optimization processing. As illustrated in FIG. 5A, the information processing device 100 functions as an optimization problem storage 10, a model parameter storage 20, a node embedder 30, a relaxation variable unit 40, a loss function calculator 50, a gradient storage 60, an approximate solution outputter 70, and so on. The information processing device 100 functions as a machine learning device during machine learning, and as a determination device during determination.

FIG. 5B is a hardware configuration diagram of the information processing device 100. As illustrated in FIG. 5B, the information processing device 100 includes a CPU 101, a RAM 102, a storage device 103, an input device 104, a display device 105, and so on.

The CPU (Central Processing Unit) 101 is a central processing unit. The CPU 101 includes one or more cores. The RAM (Random Access Memory) 102 is a volatile memory that temporarily stores programs executed by the CPU 101 and data processed by the CPU 101. The storage device 103 is a non-volatile storage device. For example, the storage device 103 may be a ROM (Read Only Memory), a solid-state drive (SSD) such as flash memory, or a hard disk driven by a hard disk drive. The storage device 103 stores the machine learning program and the determination program. The input device 104 is a device for the user to input necessary information, such as a keyboard or mouse. The display device 105 displays the approximate solution output by the approximate solution outputter 70 on a screen. The CPU 101 executes the machine learning program or the determination program to realize each unit of the information processing device 100. Note that each unit of the information processing device 100 may also be implemented using hardware such as a dedicated circuit.

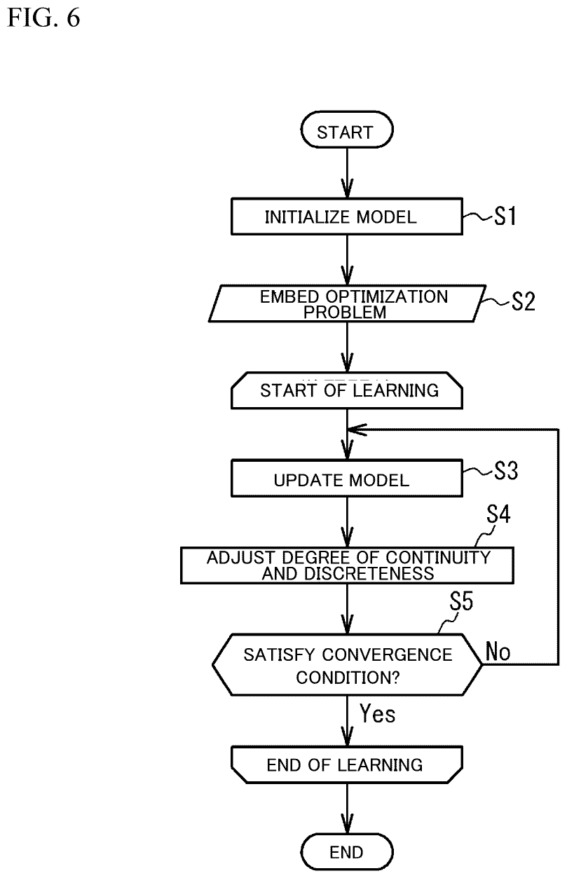

FIG. 6 is a flowchart illustrating an example of the operation of the information processing device 100 during machine learning. As illustrated in FIG. 6, the loss function calculator 50 initializes the model (step S1). Specifically, the loss function calculator 50 sets the model parameters stored in the model parameter storage 20 to predetermined initial values.

Next, the node embedder 30 embeds the optimization problem (step S2). For example, in a problem using a graph, the node embedder 30 converts the graph feature vector of the given optimization problem into an embedding vector h_{φ,G}. The relaxation variable unit 40 also sets the dynamic variables to be relaxed and parameterized by the neural network. This results in the loss function expressed by the above formula (6).

Next, the loss function calculator 50 updates the model parameters using the gradient method (step S3). The model parameters are updated using the gradients stored in the gradient storage 60. The first time step S3 is executed, the model parameters are not updated.

Next, the loss function calculator 50 adjusts the degree of discreteness to continuity (step S4). Specifically, the loss function calculator 50 calculates the loss function while gradually changing the hyperparameter λ in the formula (6) above from a negative value λ⁽⁰⁾<0 to a positive value λ^{(T)}>0.

Next, the loss function calculator 50 determines whether the convergence condition is met (step S5). For example, it is determined whether the loss function in the formula (6) above no longer falls below a specified value even after repeated execution of step S4. If step S5 returns “No,” execution resumes from step S3.

If step S5 returns “Yes,” execution of the flowchart ends. In this case, the model parameter storage 20 stores the model parameters that result in the smallest loss function.

The machine learning illustrated in FIG. 6 enables the creation of a machine learning model that minimizes the loss function in the formula (6) above. The machine learning model (model parameters) is stored in the model parameter storage 20.

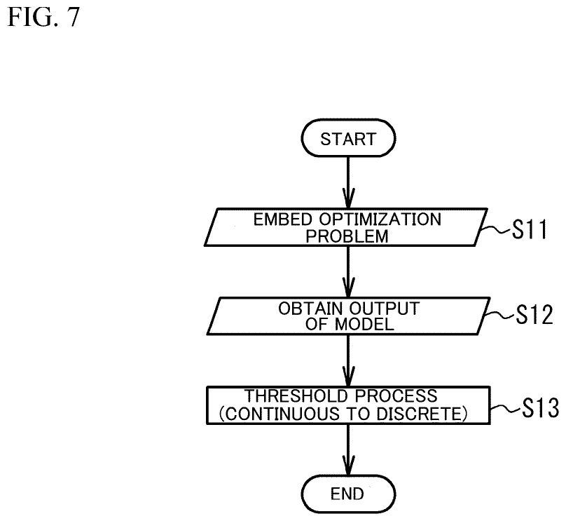

FIG. 7 is a flowchart of an example of the operation of the information processing device 100 when outputting an approximate solution to an optimization problem using the results of the machine learning model obtained by the machine learning of FIG. 6. As illustrated in FIG. 7, the node embedder 30 embeds the optimization problem (step S11).

Next, the approximate solution outputter 70 obtains the output of the machine learning model (step S12).

Next, the approximate solution outputter 70 performs threshold processing on the optimal solution output by the machine learning model (step S13). For example, a threshold is set for each value output by the machine learning model and binarized. For example, when converting each value into two values, 0 and 1, the threshold is set to 0.5, and values greater than 0.5 are set to 1, and values less than 0.5 are set to 0.

Note that in the above example, an optimization problem using a graph as the optimization target is described. Optimization problems using graphs are not particularly limited, but an example would be an energy transportation problem. The above example may also be applied to optimization problems that do not use graphs as the optimization target. Optimization problems that do not use graphs are also not particularly limited, but an example would be a corporate scheduling problem.

In the above embodiment, the loss function calculator 50 functions as an example of an executor that executes the process of machine learning a model by using a loss term corresponding to the degree of continuity or discreteness of the variable to be optimized as a cost function in the search process that incorporates continuous relaxation into the discrete optimization problem, and by changing the loss term as the search process progresses. The approximate solution outputter functions as an example of an outputter that outputs a solution by embedding the optimization problem in the machine-learned model.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium storing a calculation program for causing a computer to execute a process, the process comprising:
training a model by using a loss term corresponding to a degree of continuity or discreteness of a variable to be optimized as a cost function in a search process that incorporates continuous relaxation into a discrete optimization problem, and changing the loss term as the search process progresses.

2. The medium as claimed in claim 1,
wherein as the searching progresses, the loss term is changed from one that causes less loss the more continuous the variable is to one that causes more loss the more continuous the variable is.

3. The medium as claimed in claim 1,
wherein the discrete optimization problem is expressed in QUBO format.

4. The medium as claimed in claim 1,
wherein the process further comprises outputting a solution by embedding an optimization problem in the model.

5. A machine learning method comprising:
training a model by using a loss term corresponding to a degree of continuity or discreteness of a variable to be optimized as a cost function in a search process that incorporates continuous relaxation into a discrete optimization problem, and changing the loss term as the search process progresses.

6. The machine learning method as claimed in claim 5,
wherein as the searching progresses, the loss term is changed from one that causes less loss the more continuous the variable is to one that causes more loss the more continuous the variable is.

7. The machine learning method as claimed in claim 5,
wherein the discrete optimization problem is expressed in QUBO format.

8. The machine learning method as claimed in claim 5, further comprising:
outputting a solution by embedding an optimization problem in the model that is machine-learned in claim 5.

9. A machine learning device comprising:
a memory; and
a processor coupled to the memory and the processor configured to execute a process, the process comprising:
training a model by using a loss term corresponding to a degree of continuity or discreteness of a variable to be optimized as a cost function in a search process that incorporates continuous relaxation into a discrete optimization problem, and changing the loss term as the search process progresses.

10. The machine learning device as claimed in claim 9,
wherein as the searching progresses, the loss term is changed from one that causes less loss the more continuous the variable is to one that causes more loss the more continuous the variable is.

11. The machine learning device as claimed in claim 9,
wherein the discrete optimization problem is expressed in QUBO format.

12. The machine learning device as claimed in claim 9,
wherein the process further comprises outputting a solution by embedding an optimization problem in the model that is machine-learned in claim 9.
